(19) United States
(12) Patent Application Publication
(10) Pub. No.: US 2015/0274196 A1
(43) Pub. Date: Oct. 1, 2015

(54) CATCH-UP PREVENTION METHOD OF ACTIVE FRONT STEERING AND APPARATUS THEREOF

(71) Applicant: Hyundai Motor Company, Seoul (KR)

(72) Inventors: Ki Sung PARK, Hwa (KR); Min Chul Shin, Anyang-si (KR)

(73) Assignee: Hyundai Motor Company, Seoul (KR)

(21) Appl. No.: 14/543,226

(22) Filed: Nov. 17, 2014

(30) Foreign Application Priority Data
Apr. 1, 2014 (KR) 10-2014-0038482

(51) Int. Cl. B62D 5/00

(52) U.S. Cl. CPC B62D 5/008

(57) ABSTRACT

A catch-up prevention method of an active front steering may include (a) judging whether an output of a power steering system is required in a vehicle to which the active front steering (AFS) is applied, (b) judging whether a steering angle of a steering wheel is increased to a preset predetermined angle or more, (c) judging whether an input speed of a pinion is larger than an output speed of the pinion, and (d) lowering a gear ratio of the active front steering when (a), (b) and (c) are satisfied.

### CROSS-REFERENCE TO RELATED APPLICATION

The present application claims priority of Korean Patent Application Number 10-2014-0038482 filed on Apr. 1, 2014, the entire contents of which application are incorporated herein for all purposes by this reference.

### BACKGROUND OF INVENTION

1. Field of Invention

The present disclosure relates to a catch-up prevention method and an apparatus in an active front steering upon stopping or low-speed driving.

2. Description of Related Art

An apparatus that electronically changes a steering gear ratio according to the speed of a vehicle is called an active front steering (AFS). A vehicle with such a steering system includes a steering gear ratio varying mechanism constituted by a planet gear or a harmonic gear to vary an output angle for a driver steering wheel input. That is, an output angle through the AFS is made to be smaller than a steering wheel input angle of a driver upon high-speed driving to improve driving stability of the vehicle and the output angle through the AFS is made to be larger than the steering wheel input angle of the driver upon low/medium-speed driving to improve quickness and driving convenience of the vehicle.

An actuator of the AFS may be mounted on a column, a U-joint, or a pinion by considering a periphery layout and since a power assist is not provided, the actuator is applied together with a hydraulic power steering or electric power steering system.

FIG. 7 is a diagram illustrating a configuration of an active front steering in which an AFS actuator is positioned on a column and is adopted together with a rack driving power steering system.

The configuration illustrates a steering wheel 10 in which a steering angle of the driver is input, an actuator 20 which varies a steering gear ratio and an electronic control unit (ECU) 30 controlling the actuator 20, a rack driving steering gear box 50 providing the power assist, and an electronic stability control (ESC) that moves a vehicle as the driver intends by stabilizing a vehicle posture.

FIG. 8 is a diagram showing an effect of a vehicle to which the active front steering is applied.

The vehicle to which the active front steering is applied as illustrated in FIG. 8 may show an effect in which a steering gear ratio for each vehicle speed is actively varied to improve steering convenience and driving stability. In addition, a function to assist avoiding a risk by steering a front wheel of the vehicle more rapidly than avoidance steering which the driver intends under a quick steering situation before a collision and a function to stabilize the vehicle posture through a front wheel counter steering control when a behavior of the vehicle is instable through a cooperative control with an electronic stability control (ESC) may also be additionally implemented.

However, in general, the active front steering is controlled at a high gear ratio when the vehicle stops or is driven at the low speed to improve driving convenience and is controlled at a low gear ratio when the vehicle is at the high speed to improve traveling stability, but the active front steering (AFS) is engaged at a high gear ratio when the vehicle stops or is driven at the low speed, and as a result, an effort becomes excessive at the end and a catch-up phenomenon occurs, thereby exerting a bad influence on steering piling. In addition, in order to solve such a problem, in a system to which a motor driven power steering (MDPS) is applied, a capacity of an MDPS motor needs to be increased, and as a result, excessive development cost and development schedule are caused.

The information disclosed in this Background section is only for enhancement of understanding of the general background of the invention and should not be taken as an acknowledgement or any form of suggestion that this information forms the prior art already known to a person skilled in the art

### SUMMARY OF INVENTION

The present disclosure has been made in an effort to solve the above-described problems associated with the prior art and/or other problems, and the present disclosure has been made in an effort to provide a catch-up prevention method of an active front steering that can solve catch-up and excessive effort problems caused due to an insufficient system capacity at a steering end through control logic of an active front steering (AFS) without an increment in size of a motor of a motor driven power steering in a vehicle to which the AFS is applied.

In various aspects, the present disclosure provides a catch-up prevention method of an active front steering, including: (a) judging whether an output of a power steering system is required in a vehicle to which the active front steering (AFS) is applied; (b) judging whether a steering angle of a steering wheel is increased to a preset predetermined angle or more; (c) judging whether an input speed of a pinion is larger than an output speed of the pinion; and (d) lowering a gear ratio of the active front steering when (a), (b) and (c) are satisfied.

In an aspect, in the judging of whether the output of a power steering system is required, it may judge whether the gear ratio of the active front steering is larger than 1.0. In another aspect, in the judging of whether the output of the active front steering is required, it may judge whether the vehicle is in a stop state or in a low-speed state having a predetermined speed or less. In still another aspect, the preset predetermined angle may be approximately 300°.

In yet another aspect, in the lowering of the gear ratio of the active front steering, a new gear ratio of the active front steering may be set by lowering the gear ratio of the active front steering by approximately 0.02. In still yet another aspect, in the judging of whether the input speed of the pinion is larger than the output speed of the pinion, the input speed of the pinion may be calculated by multiplying a steering angle speed of the steering wheel by the gear ratio of the active front steering.

In still yet another aspect, in the judging of whether the input speed of the pinion is larger than the output speed of the pinion, the output speed of the pinion may be calculated by using

$$\frac{\begin{matrix}Motor rpm \times ball screw reduction deceleration ratio \times \\ ball screw lead \times 360 ° \text{/} s )\end{matrix} }{60 \times rackgear ratio} .$$

In various other aspects, the present disclosure provides a catch-up prevention apparatus of an active front steering, including: a controller giving a command of varying a gear ratio by judging whether an output of a power steering system is required in a vehicle to which the active front steering (AFS) is applied and judging whether a steering angle of a steering wheel is increased to a preset predetermined angle or more; and an active front steering controlling the gear ratio according to the command from the controller.

In an aspect, the preset predetermined angle may be approximately 300°. In another aspect, the controller may command the gear ratio of the active front steering to be lowered by approximately 0.02 when the controller judges that the output of the power steering system is required and a steering angle of a steering wheel is a preset predetermined angle or more. In still another aspect, in the judging of whether the output of the active front steering is required, it may judge whether the gear ratio of the active front steering is larger than 1.0.

As described above, the catch-up prevention method of the active front steering system according to the present disclosure have the following effects or advantages.

Although a steering wheel is turned up to a steering end upon stopping and low-speed driving, a steering feel can be improved and reliability can be created for a driver by preventing a catch-up or excessive effort phenomenon. Since a motor capacity does not need to be increased in order to prevent the catch-up or excessive effort phenomenon, cost can be saved.

Other aspects and exemplary embodiments of the disclosure are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the disclosure are discussed infra.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a diagram illustrating a steering gear ratio variation effect by application of an active front steering;

FIG. 2 is a flowchart illustrating an operation process of an exemplary catch-up prevention method of an active front steering according to the present disclosure;

FIG. 3A, FIG. 3B, FIG. 3C and FIG. 3D are diagrams illustrating a change of a gear ratio in an exemplary catch-up prevention method of an active front steering according to the present disclosure compared with a system gear ratio of the existing active front steering;

FIG. 4 is a diagram illustrating that a catch-up phenomenon occurs at a steering end when the active front steering is driven by the known control method;

FIG. 5 is a table illustrating a value of a rack thrust and a motor output required in a part where the catch-up phenomenon occurs acquired through a test;

FIG. 6 is a diagram illustrating that the catch-up phenomenon is prevented by an exemplary catch-up prevention method of an active front steering according to the present disclosure;

FIG. 7 is a diagram illustrating a configuration of the active front steering; and

FIG. 8 is a diagram showing an effect of a vehicle to which the active front steering is applied.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

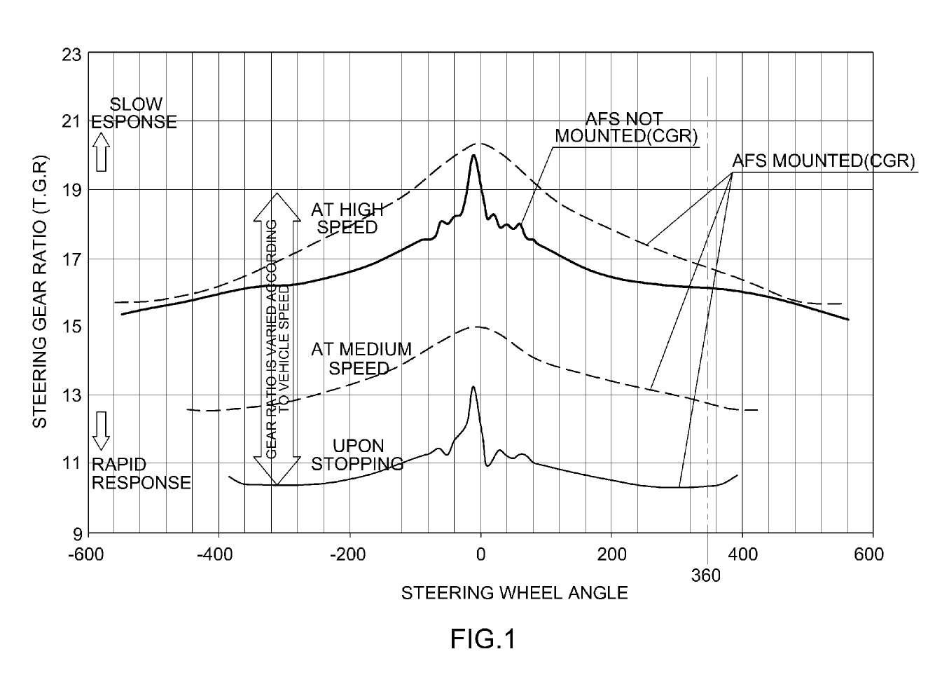

A graph showing a pattern in which a steering gear ratio is changed according to an angle of a steering wheel is illustrated at the left side of FIG. 1. That is, the left graph shows a pattern in which a total gear ratio (T.G.R) showing the steering wheel angle required to turn a tire by 1° is changed. The total gear radio is one of criteria for judging responsiveness of a vehicle.

In FIG. 1, it may be verified that a steering gear ratio is changed in the form of only one curve according to the angle of the steering wheel in a vehicle without the active front steering. However, it may be verified that the gear ratio is actively varied according to the speed of the vehicle with different curve graphs when a vehicle with the active front steering is driven at a high speed and a medium speed, and stops. In addition, busy steering is improved by a high gear ratio to improve driving convenience when the vehicle with the active front steering is when stopping or being driven at the low speed and driving stability is improved by a low gear ratio when the vehicle is driven at the high speed.

The high gear radio disclosed in the present disclosure may be judged in terms of the total gear ratio and a single gear ratio, and as the total gear ratio which is the steering wheel angle required to turn the tire by 1° is smaller and as the single gear ratio of a steering gear box meaning a distance of a rack bar which moves when turning a pinion by 1° is larger, the high gear ratio means the high gear ratio from the viewpoint of the vehicle.

The busy steering disclosed in the present disclosure is represented by the number of steering wheel turns. When a vehicle in which the number of steering wheel turns is 1 and a vehicle in which the number of steering wheel turns is 1.5 in full-turn are compared with each other, an effort of the driver in the vehicle in which the number of wheel turns is 1 is less required than the vehicle in which the number of wheel turns is 1.5, and as a result, the busy steering is enhanced.

The catch-up phenomenon disclosed in the present disclosure represents a phenomenon in which a suspension feel occurs as if the steering wheel cannot be followed and is pulled reversely when the driver turns the steering wheel due to an insufficient flow in a hydraulic power steering system and insufficient motor capacity in a motor driven power steering (MDPS) system.

This phenomenon occurs when a piston in the steering gear box cannot be followed due to an insufficient flow in the hydraulic power steering system with a speed of a steering wheel which the driver turnsor an output is insufficient in a predetermined rotational speed (rpm) of a MDPS motor in the motor driven power steering system.

In order to solve the problem, a capacity of the MDPS motor is increased in a vehicle to which both of the active front steering and the motor driven power steering system (MDPS) are applied. However, this may bring about an overall redesign of the motor such as new development of a motor mold and cause excessive development and development schedule.

Accordingly, the catch-up prevention method of the active front steering according to various embodiments of the present disclosure is intended to solve the catch-up phenomenon which occurs by temporarily lowering the gear ratio of the active front steering only when the catch-up occurs at a stop steering end (e.g., the steering wheel angle at approximately 300° or more in the present disclosure) requiring large assist power without new development of the MDPS motor.

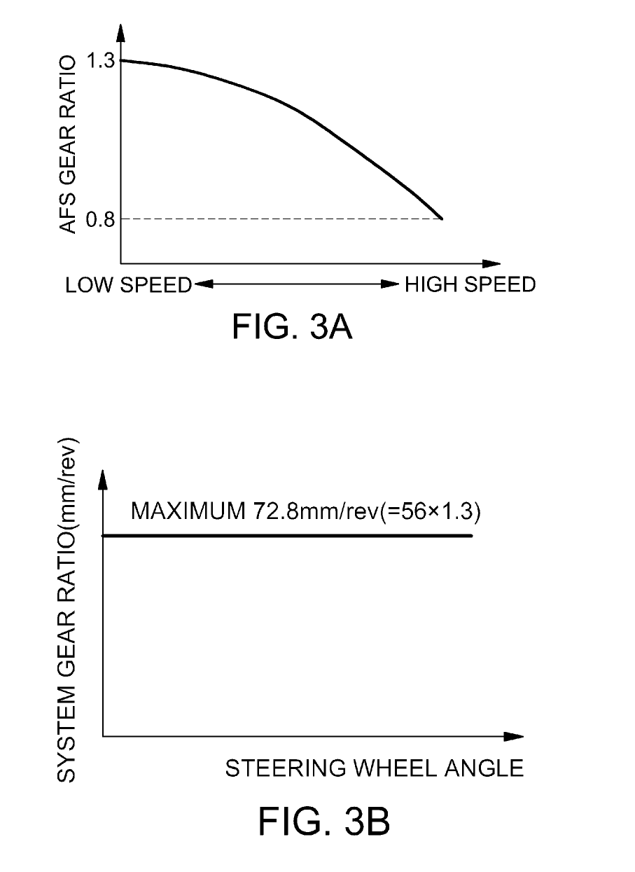

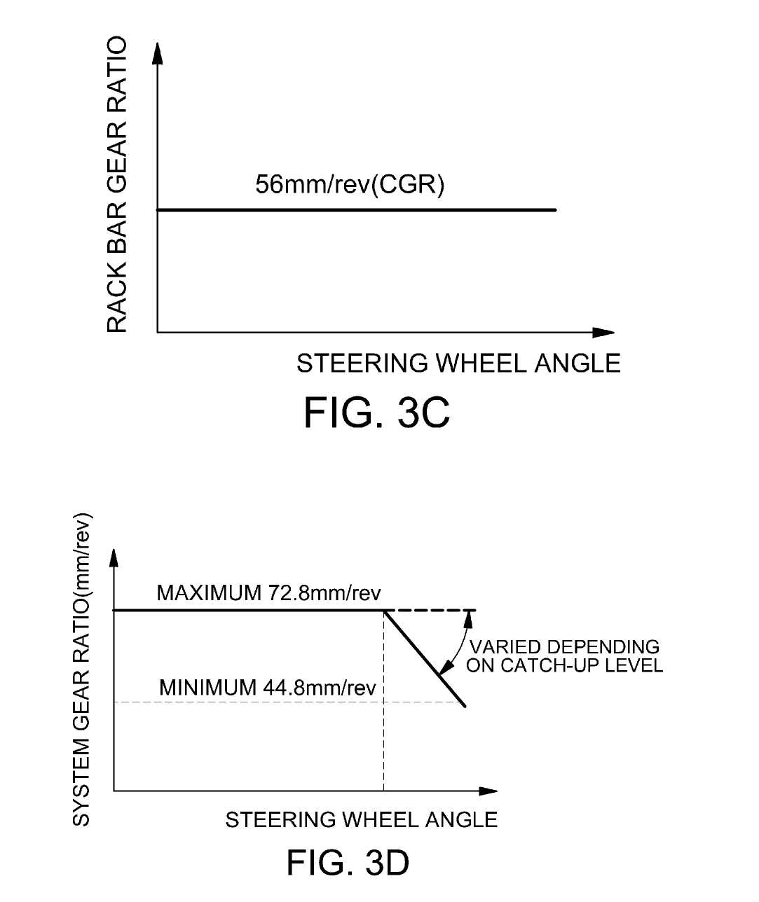

The total gear ratio of the steering system to which the active front steering is applied is equal to a value acquired by multiplying the single gear ratio of the power steering gear box by the gear ratio of the active front steering. By way of illustration, in FIG. 3, the gear ratio of the active front steering may be controlled from 0.8 to 1.3. In addition, the gear ratio of the rack bar is continuously equal to 56 mm/rev. Accordingly, according to various embodiments of the present disclosure, a final system gear ratio may be controlled in the range of 44.8 to 72.8 mm/rev and the busy steering is enhanced and the driving convenience is improved by the high gear ratio of 72.8 mm/rev at the steering wheel angle of approximately 300° or less upon stopping and upon the low-speed driving and when the catch-up is to occur in the range of a steering wheel angle of approximately 300° or more, the catch-up is prevented from occurring by lowering the gear ratio to a maximum of 44.8 mm/rev.

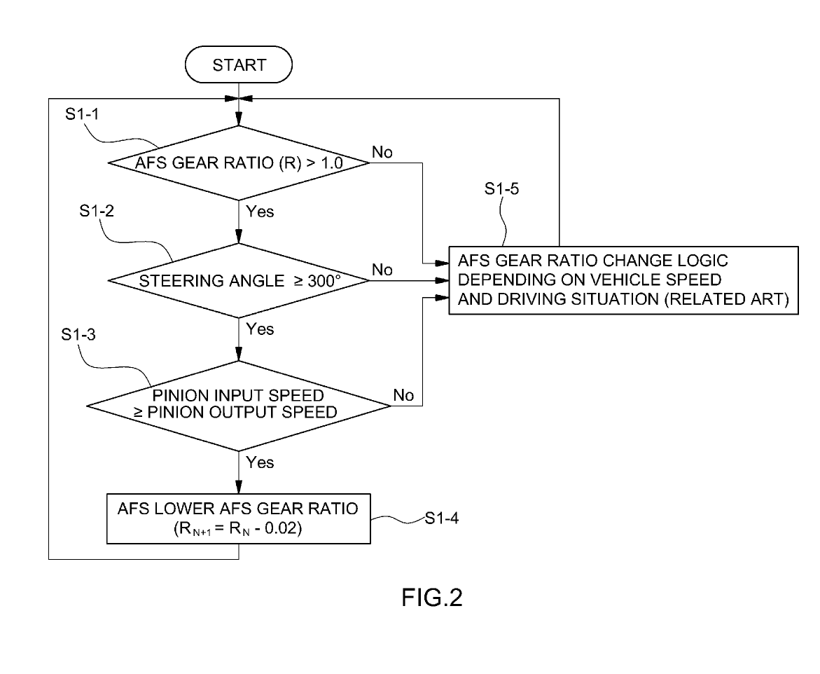

FIG. 2 is a flowchart illustrating an operation process of a catch-up prevention method of an active front steering according to an exemplary embodiment of the present disclosure.

In the catch-up prevention method of the active front steering according to various embodiments of the present disclosure, the active front steering is engaged at the high gear ratio upon stopping or upon the low-speed driving in the vehicle with the active front steering and in this case, a large output is required in the system at the steering end and it is recognized that the catch-up or excessive effort phenomenon occurs due to the insufficient motor capacity and the following steps may be performed as the disclosure for solving the phenomenon.

First, in the catch-up prevention method of the active front steering according to various embodiments of the present disclosure, a step of judging whether the gear ratio of the active front steering is larger than 1.0 may be performed(S1-1). Herein, the case in which the gear ratio of the active front steering is 1.0 represents a situation in which the active front steering does not influence the total gear ratio of the system, that is, the same condition as a system without the active front steering and the case in which the gear ratio of the active front steering is larger than 1 represents a situation in which the total gear ratio of the steering system is increased, and as a result, a larger output is required as compared with the system without the active front steering. This situation is a situation upon stopping or at the low speed and the judgment step may be substituted with even a condition when the vehicle is driven at a predetermined vehicle speed or less.

Subsequently, a process of judging whether the steering angle of the steering wheel is equal to or larger than a predetermined angle such as 300° or approximately 300° may be performed (S1-2). In step S1-2, the reason for requiring a condition to judge whether the steering angle is 300° or more is that the steering angle of the steering wheel of 300° or more is a region used upon stopping or during the low-speed driving and when catch-up prevention logic is actuated during the high-speed driving and the gear ratio is rapidly changed, it is difficult to ensure the driving stability and another reason is that the high gear ratio is maintained up to a minimum of 300° to improve the driving convenience upon stopping and the low-speed driving due to a decrease in the number of wheel turns. Herein, a reference angle, that is, a preset predetermined angle may be controlled to an appropriate value.

Subsequently, in the catch-up prevention method of the active front steering according to various embodiments of the present disclosure, a process of judging whether an input speed of the pinion is larger than an output speed of the pinion may be performed (S1-3). Herein, the disclosed input speed of the pinion is equal to an output speed of the AFS output through the active front steering of the column and the output speed of the pinion means a speed at which a motor of a rack driving power steering transports the rack bar. Since the output speed of the pinion may not instantaneously follow the input speed of the pinion under the catch-up situation, it may be judged that the catch-up occurs when the input speed of the pinion is larger than the output speed.

In addition, the output speed of the pinion may be acquired through

$$\frac{\begin{matrix}Motor rpm \times ball screw reduction deceleration ratio \times \\ ball screw lead \times 360 ° \text{/} s )\end{matrix} }{60 \times rackgear ratio} .$$

When it is judged that all of the steps are satisfied, lowering the gear ratio of the active front steering may be performed in the catch-up prevention method of the active front steering according to various embodiments of the present disclosure (S1-4).

In some embodiments, the gear ratio of the active front steering may be lowered such as by 0.02 or by approximately 0.02.

In addition, after the gear ratio of the active front steering is lowered by approximately 0.02, a process of returning to the first step of judging whether the gear ratio of the active front steering is larger than 1.0 again may be performed. A ratio of 0.02 used while lowering the gear ratio is one example and an appropriate value may be selected, preset or readily adjusted.

By continuously repeating the steps (all processes within several ms are substantially performed), the active front steering according to various embodiments of the present disclosure naturally lowers the gear ratio of the active front steering to prevent the catch-up or excessive effort phenomenon from occurring.

In addition, if no step satisfies each corresponding requirement, the method proceeds to step S1-5, in which the gear ratio may be changed based on the vehicle speed and/or driving situation. That is, in the catch-up prevention method of the active front steering according to various embodiments of the present disclosure, when the steering wheel is unexpectedly largely controlled upon stopping and the low-speed driving, the gear ratio of the active front steering is naturally lowered in order to prevent the excessive effort phenomenon or the catch-up phenomenon from occurring and in other states, the gear ratio of the active front steering may be normally changed depending on the vehicle speed.

FIGS. 3A-3D are diagrams illustrating a change of a gear ratio in the catch-up prevention method of the active front steering according to various embodiments of the present disclosure compared with a system gear ratio of the existing active front steering. The single gear ratio of the active front steering may be, for example, 1.3 upon the low-speed driving and may be varied up to a gear ratio of, for example, 0.8 at a higher speed. In addition, the gear ratio of the rack bar is fixed to, for example, 56 mm/rev.

The existing active front steering maintained a maximum gear ratio regardless of the angle of the steering wheel in steering while stopping even though the existing active front steering may change the gear ratio of the active front steering. That is, since the gear ratio of the steering system of maximum 72.8 mm/rev is maintained, when the angle of the steering wheel becomes larger and the effort is excessive at the steering end or the catch-up phenomenon occurs, the capacity of the motor needs to be increased in order to solve the problem.

However, the catch-up prevention method of the active front steering according to various embodiments of the present disclosure controls the total gear ratio of the system from maximum 72.8 mm/rev to minimum 44.8 mm/rev by naturally lowering the gear ratio of the active front steering to prevent the catch-up phenomenon from occurring.

The catch-up prevention method of the active front steering according to various embodiments of the present disclosure may minimize the occurrence of the excessive effort phenomenon and the catch-up phenomenon at the steering end by maintaining the high gear ratio at up to a minimum of 300° and decreasing the gear ratio at the steering wheel angle of 300° or more in order to improve the driving convenience by decreasing the number of wheel turns when the steering wheel is controlled while the vehicle stops. Further, the gear ratio is prevented from being rapidly changed by the catch-up prevention method at 300° or less to ensure the driving stability.

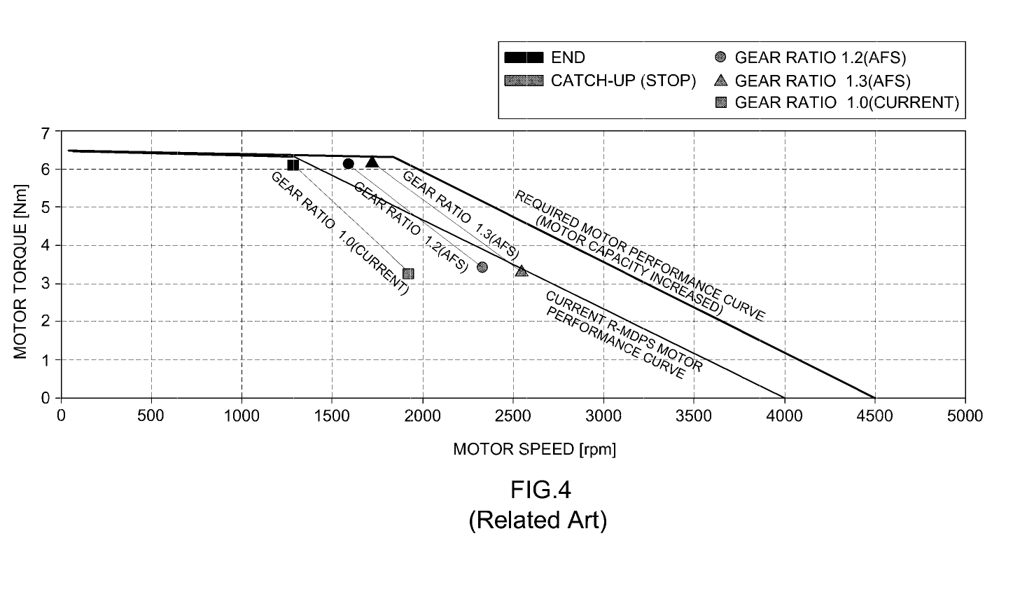

FIGS. 3A-3D are diagrams illustrating that the catch-up phenomenon is prevented without the increase of the motor capacity according to the catch-up prevention method of the active front steering according to various embodiments of the present disclosure in a rack type motor driven power steering (R-MDPS). FIG. 4 is a diagram illustrating that a catch-up phenomenon occurs at a steering end when the active front steering is driven by the known control method.

In FIG. 4, when the gear ratio of the active front steering is 1.0, it may be verified that the catch-up phenomenon does not occur while turning the steering wheel to the end from a stop state. However, when the gear ratio of the active front steering increases from 1.2 to 1.3, the catch-up phenomenon occurs out of torque which a motor of the current rack type motor driven power steering is capable of bearing.

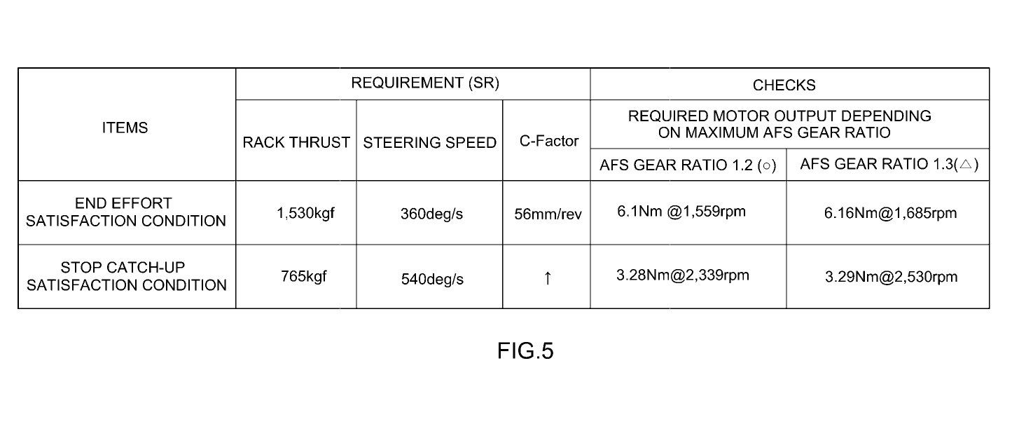

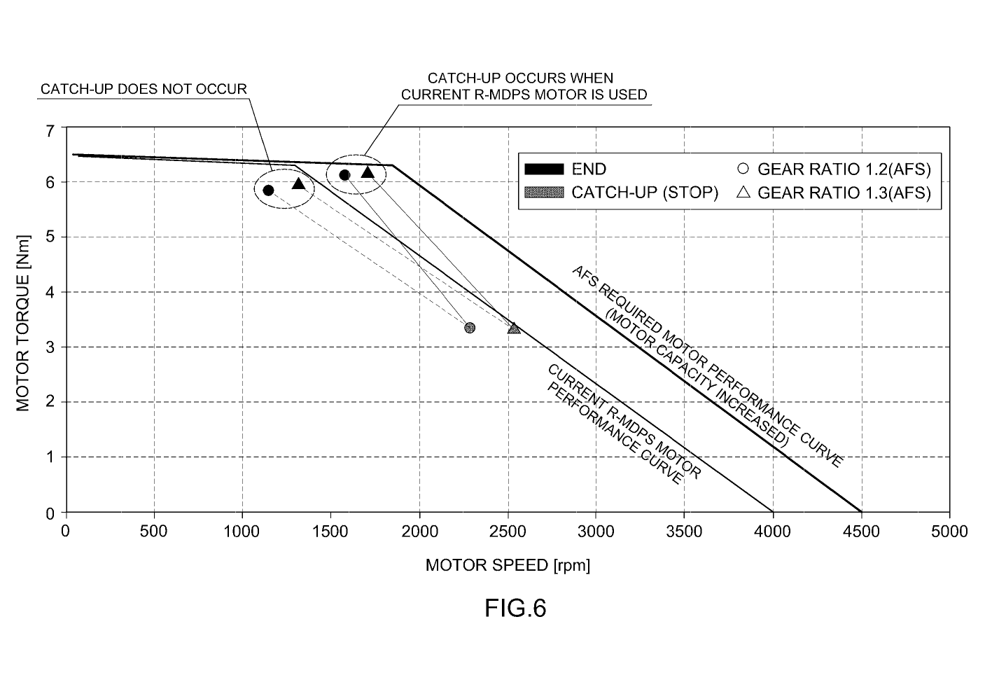

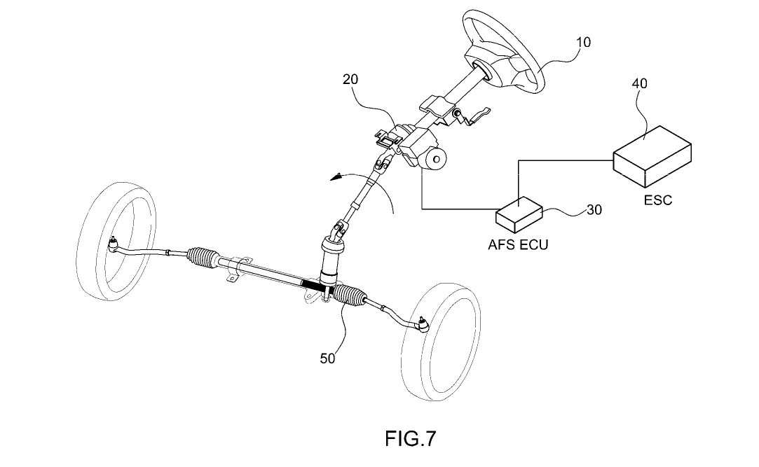

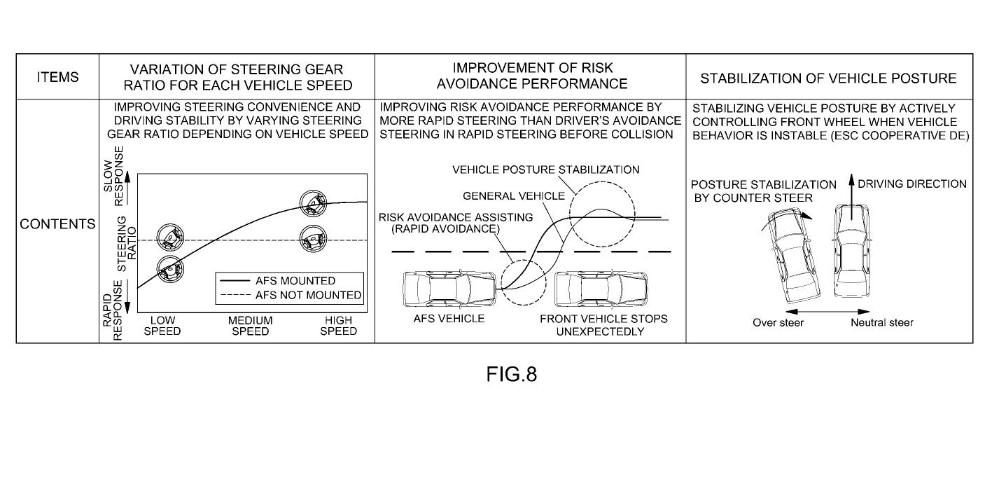

FIG. 5 is a table illustrating a value of a rack thrust and a motor output required in a part where the catch-up phenomenon occurs acquired through a test. That is, as known even through FIG. 4, the rack thrust needs to be 1530 kgf in order to satisfy the effort at the steering end and an output of the motor required for solving the rack thrust is 6.1 Nm (1559 rpm) when the single gear ratio of the active front steering is 1.2 and 6.16 Nm (1685 rpm) when the single gear ratio is 1.3.

Therefore, the catch-up phenomenon may be prevented by using a new motor having an increased capacity, which may cover up to a deviated torque point in order to solve the problem, but the catch-up prevention method of the active front steering according to various embodiments of the present disclosure naturally lowers the single gear ratio of the active front steering to simply solve the catch-up phenomenon.

FIG. 5 is a diagram illustrating that the catch-up phenomenon is prevented by the catch-up prevention method of the active front steering according to various embodiments of the present disclosure. According to the catch-up prevention method of the active front steering according to various embodiments of the present disclosure, it may be verified that the single gear ratio of the active front steering is naturally lowered without increasing the capacity of the motor to prevent the catch-up phenomenon from occurring.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A catch-up prevention method of an active front steering, comprising:
(a) judging whether an output of a power steering system is required in a vehicle to which the active front steering (AFS) is applied;
(b) judging whether a steering angle of a steering wheel is increased to a preset predetermined angle or more;
(c) judging whether an input speed of a pinion is larger than an output speed of the pinion; and
(d) lowering a gear ratio of the active front steering when (a), (b) and (c) are satisfied.

2. The method of claim 1, wherein in the judging of whether the output of the power steering system is required, it judges whether the gear ratio of the active front steering is larger than 1.0.

3. The method of claim 1, wherein in the judging of whether the output of the active front steering is required, it judges whether the vehicle is in a stop state or in a low-speed state having a predetermined speed or less.

4. The method of claim 1, wherein the preset predetermined angle is approximately 300°.

5. The method of claim 1, wherein in the lowering of the gear ratio of the active front steering, a new gear ratio of the active front steering is set by lowering the gear ratio of the active front steering by approximately 0.02.

6. The method of claim 1, wherein in the judging of whether the input speed of the pinion is larger than the output speed of the pinion, the input speed of the pinion is calculated by multiplying a steering angle speed of the steering wheel by the gear ratio of the active front steering.

7. The method of claim 1, wherein in the judging of whether the input speed of the pinion is larger than the output speed of the pinion, the output speed of the pinion is calculated by using
$$\frac{\begin{matrix}Motor rpm \times ball screw reduction deceleration ratio \times \\ ball screw lead \times 360 ° \text{/} s )\end{matrix} }{60 \times rackgear ratio} .$$

8. A catch-up prevention apparatus of an active front steering, comprising:
a controller giving a command of varying a gear ratio by judging whether an output of a power steering system is required in a vehicle to which the active front steering (AFS) is applied and judging whether a steering angle of a steering wheel is a preset predetermined angle or more; and
an active front steering controlling the gear ratio according to the command from the controller.

9. The apparatus of claim 8, wherein the preset predetermined angle is approximately 300°.

10. The apparatus of claim 8, wherein the controller commands to lower the gear ratio of the active front steering by approximately 0.02 when it is determined that the output of the power steering system is required and a steering angle of a steering wheel is a preset predetermined angle or more.

11. The apparatus of claim 8, wherein in the judging of whether the output of the active front steering is required, it judges whether the gear ratio of the active front steering is larger than 1.0.
